(19) United States
(12) Patent Application Publication
(10) Pub. No.: US 2013/0008310 A1
(43) Pub. Date: Jan. 10, 2013

(54) ALCOHOL-BASED GAS STRIPPING PROCESS

(75) Inventors: Adisorn Aroonwilas, Regina (CA); Amornvadee Veawab, Regina (CA)

(73) Assignee: UNIVERSITY OF REGINA, Regina, SK (CA)

(21) Appl. No.: 13/515,264

(22) PCT Filed: Dec. 8, 2010
(86) PCT No.: PCT/CA10/01970

§ 371 Date: Sep. 24, 2012

Related U.S. Application Data
(60) Provisional application No. 61/267,922, filed on Dec. 9, 2009.

(51) Int. Cl. B01D 53/14

(52) U.S. Cl. 95/232; 95/236; 95/235; 96/234

(57) ABSTRACT

The present disclosure relates to a method for stripping acid gases, exemplified by carbon dioxide, from absorption media and/Alcohol selected from those having a boiling point lower than the boiling point of the absorption medium and/or adsorption medium.

### FIELD

This disclosure relates to a method for stripping acid gases such as carbon dioxide from an absorption or adsorption medium. The disclosure further relates to processes, uses, and apparatus.

### BACKGROUND

Large-scale combustion processes are commonly used for municipal and industrial energy production, in the manufacturing of refined products from raw ores and other crude materials, and for the disposal of municipal and industrial waste materials. Such combustion processes typically produce on a continuous basis, significant volumes of gaseous exhaust waste streams that contain one or more undesirable gaseous compounds. comprise one or more of the acid gases such as carbon dioxide (CO₂), sulfur dioxide (SO₂), and oxides of nitrogen (NOₓ), which can cause significant environmental pollution and health risks. In particular, increasing concentrations of atmospheric CO₂ are thought to be the primary cause of global warming.

Gas absorption, separation and recovery processes have long been provided for both industrial and environmental purposes. Industrial applications typically involve the separation and removal of at least one gaseous component from a process gas stream in order to enhance the quality of gas products produced and/or to prevent undesirable downstream operational problems that might subsequently occur in downstream processes. Examples include the removal of CO₂ and/or hydrogen sulfide (H₂S) from natural gas and synthesis gas or the removal of volatile organic compounds (VOCs) or other gases (e.g. nitrogen (N₂), oxygen (O₂), hydrogen (H₂)) from industrial process gas streams. Environmental applications typically involve the removal of at least one gaseous component such as SO₂, CO₂, NOₓ, or mercury (Hg) from combustion flue or exhaust gas streams in order to reduce emissions of pollutants.

Numerous systems for scrubbing undesirable gaseous compounds from combustion flue or exhaust gas streams exist and typically involve the use of a counterflow solvent, such as one comprising one or more alkanolamines, against a gas stream containing the undesirable components. Such systems are commonly referred to as countercurrent absorbers and strippers. Certain of the systems and their operation are described in Kohl and Neilson in Gas Purification, 5^{th} Edition (1997, Elsivier B. V.); US 2003/0221555; US 2005/0169825; US 2007/0044658; US 2007/0077188; US 2009/0104098; US 2009/0151318; US 2009/0151564; US 2009/0151566; US 2009/0155889; U.S. Pat. No. 3,725,529; U.S. Pat. No. 5,220,782; U.S. Pat. No. 6,270,739; U.S. Pat. No. 6,436,174; U.S. Pat. No. 7,001,519; U.S. Pat. No. 7,388,120; WO 89/07979; WO 2004/089512; WO 2006/108532; WO 2009/003238; WO 2009/052313; and EP 544,515.

Most acid gas removal methods include a step for regenerating the absorption or adsorption medium. This step is variously known as desorption, regeneration, or stripping. One common method of performing the stripping step (for example, in CO₂ removal process) is to contact the CO₂-rich scrubbing medium with steam. The steam drives off the CO₂ from the medium and the CO₂-lean medium can be reused. The energy required to generate the steam is costly and reduces the overall efficiency of the system.

### SUMMARY

The present disclosure relates to a method for stripping acid gases, exemplified by carbon dioxide, from absorption media and/or adsorption media using an alcohol selected from those having a boiling point lower than the boiling point of the absorption medium and/or adsorption medium.

The disclosure further provides the use of gaseous alcohols and/or alcohol vapours, for stripping an acid gas from absorption media and/or adsorption media.

The disclosure further provides use of heat recovery apparatus and processes for regeneration and recirculation of an alcohol stripping component (or carrier). It is optional to employ exogenous low-grade heat inputs for regeneration and recirculation of an alcohol stripping component (or carrier).

The disclosure further provides the use of heat pumps for recovery and utilization of waste heat generated during the gas-stripping processes.

The disclosure further provides a process for stripping an acid gas from an absorption medium and/or adsorption medium, said process comprising:

(a) contacting an acid gas-enriched absorption medium and/or adsorption medium with a gaseous alcohol;

(b) recovering the lean i.e., acid gas-depleted, absorption medium and/or adsorption medium;

(c) preferably, cooling the acid gas-enriched alcohol by passage through a heat-exchange apparatus to separate the acid gas from the alcohol;

(d) preferably, regenerating the alcohol into a gaseous vapour stream; and

(e) optionally, recovering waste heat with one or more heat-pumps.

The disclosure further provides an apparatus for stripping an acid gas from absorption medium and/or adsorption medium.

As used herein, the term ‘rich absorption and/or adsorption media’ refers to media that has absorbed a relatively greater amount of acid gas compared to lean media.

As used herein, the term ‘lean absorption and/or adsorption media’ refers to media that comprises no or low amounts of acid gas.

As used herein, the term ‘acid gas’ refers to gases that form acidic solutions when mixed with water.

As used herein, the term ‘boiling point’ refers to the boiling point at standard temperature and pressure.

### DESCRIPTION OF THE DRAWINGS

The present disclosure will be described in conjunction with reference to the following drawings in which:

FIG. 1 is a schematic representation of an exemplary apparatus suitable for operation therein of an exemplary process of the present disclosure for alcohol-based CO₂ stripping process from absorption media; and

FIG. 2 is a schematic representation of an exemplary apparatus suitable for operation therein of an exemplary process of the present disclosure for alcohol-based CO₂ stripping process from adsorption media.

### DETAILED DESCRIPTION

In an embodiment of the present disclosure there is provided a method of stripping acid gas from absorption media and/or adsorption media using alcohols. Any suitable alcohol may be used herein. For example, short chain alcohols such as C₁-C₆ or C₁-C₄ alcohols may be used herein. Exemplary alcohols include methanol, ethanol, iso-propanol, n-propanol, and combinations thereof.

While not wishing to be bound by theory, it is believed that, because the stripping solvent vaporises at a lower temperature, the present disclosure allows the stripping to be performed at lower temperatures compared to the conventional stripping operation using steam. This can save energy and improve the efficiency of regeneration of media (absorbent and/or adsorbent). Furthermore, due to the lower operating temperatures, the present disclosure allows for different materials to be used in the construction of the apparatus used for the stripping process. Such materials may, for example, be lighter and/or cheaper than those currently used. In addition, it may be possible to use low-quality heat sources such as geothermal energy for the stripping process.

The present method may be used to strip any suitable gas from an absorption medium and/or adsorption medium. For example, gases that may be stripped are exemplified by CO₂, NO_{N}, SO₂, and the like.

The present disclosure provides for stripping acid gas from an absorption medium and/or adsorption medium. Typically absorption media are liquids and adsorption media are solids. Any suitable type of absorption media may be stripped using the present method. Examples of absorption media include, but are not limited to, monoethanolamine (MEA), diglycolamine (DGA), diethanolamine (DEA), methyldiethanolamine (MDEA), 2-amino-2-methyl-1-propanol (AMP), piperazine (PZ), ammonia, amines, alkanolamines, derivatives and/or combinations thereof These amines should be used as aqueous solutions.

The alcohol stripper preferably has a lower boiling point than the absorption media and/or adsorption media so that the alcohol is a vapour, i.e., gaseous form when it contacts the media.

In an embodiment of the present disclosure rich absorption media is delivered to a stripping vessel. The rich media may conveniently be delivered to, or near, the top of the stripping vessel. For embodiments using adsorption media, the rich media may be packed in an adsorption vessel where its operation is switched to the stripping mode. An alcohol, such as methanol, ethanol, iso-propanol, and/or n-propanol, is delivered to the stripping vessel. The alcohol may conveniently be delivered at, or near, the bottom of the stripping vessel or at various points in the vessel. The alcohol may be delivered as a gas or a vapour. Alternatively, the alcohol may be converted to a gas or a vapour in situ.

The gaseous alcohol rises through the vessel and contacts the descending absorption media and/or adsorption media. This contact allows the alcohol to strip at least a portion of the acid gas from the media. The lean media can be collected and, if desired, recycled. The acid gas-alcohol vapour rises through the vessel, leaves the vessel and may be cooled, preferably via a heat-recovery and exchange mechanism, and condensed to separate the alcohol and acid gas. The alcohol may be reused for further stripping. The acid gas may be collected for storage, and then used for other industrial purposes or disposed of in another suitable manner. The heat recovered in the heat-recovery and exchange mechanism may, for example, be transmitted to an alcohol vapour generator (reboiler) via a heat-pump thus improving the efficiency of the system.

The vessel may be of any suitable type. For example, suitable gas-liquid or gas-solid contactors. For example, packed, membrane, module, spray, tray vessels may be used. Or a suitable combination thereof The vessel may be a column.

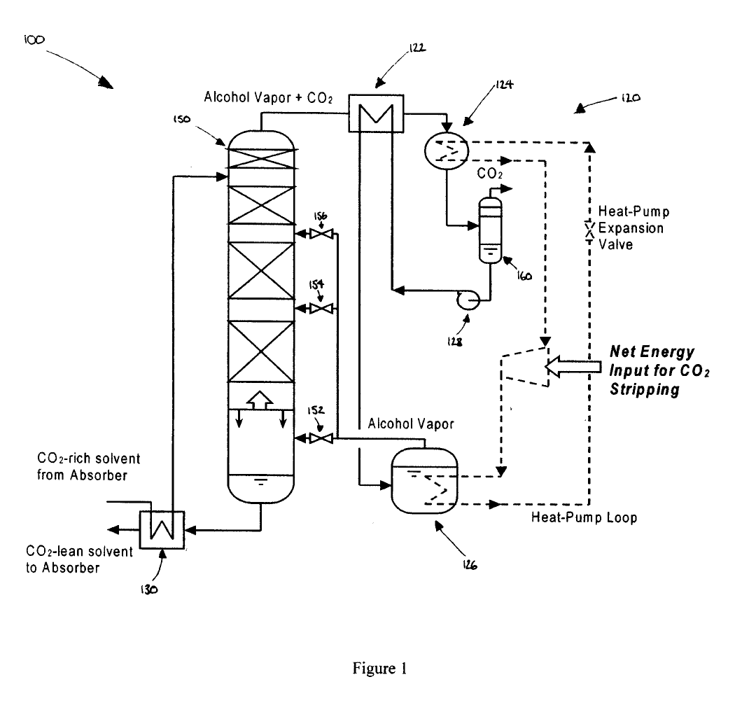

FIG. 1 is a schematic representation of an exemplary apparatus suitable for operation therein of an exemplary process of the present disclosure for alcohol-based CO₂ stripping process from an amine absorption medium. The apparatus (100) includes a heat-recovery unit (120) for generation and recirculation of alcohol vapour within CO₂ stripping process. CO₂-rich amine solution from the absorber is heated by a cross heat-exchanger (130) with CO₂-lean solution from the stripper. The heated solution is fed to the stripper (150) top, and travels downward against the upward flow of hot alcohol vapour that is introduced to the bottom and/or the sides of the stripper (150). In the presence of stripping driving force, CO₂ is released from the liquid and leaves the stripper top with alcohol vapour while CO₂-lean solution leaves the stripper at the bottom without boiling. A vapour mixture of alcohol and CO₂ from the stripper is cooled by heat recovery (122) and overhead condensers (124) to separate alcohol and CO₂. The liquid alcohol is collected in an accumulator (160) then pumped by a liquid pump (128) through the recovery condenser (122) and a reboiler (126) to evaporate into alcohol vapour before being reused in the stripper (150). Since the alcohol used is always circulated within the system, its loss and makeup rely on appropriate operating conditions of the stripper. Note that temperature of the stripper must be kept above a boiling point of alcohol but below that of absorption medium to ensure the presence of alcohol vapour and prevent a great extent of water vaporization from liquid solution. The amount of alcohol vapour required and a number of alcohol injection points (152, 154, 156) along the stripper (150) height will depend on the magnitude of stripping driving force that is required.

Because of a lower temperature of reboiler (126) used for alcohol vaporization, the heat-pump concept can be readily integrated into the proposed stripping operation. From FIG. 1, a heat-pump loop (dotted lines) is applied to extract heat from overhead condenser (124) and utilize it for heating reboiler (126) at a higher temperature. Based on a preliminary evaluation, a heat pump with refrigerant R-134a running between 10° C. (temperature of cooling medium for condenser) and 90° C. (temperature of heating medium for reboiler) offers a heat-pump coefficient of performance (COP_{HP}) of 2.5. This suggests that only 40% of energy supplied to the reboiler (126) is needed from an external source to drive heat-pump compressor (128), thus presenting a great potential for energy saving. While not wishing to be bound by theory, it is believed that it would be problematic to apply the heat pump concept to current stripping operations because reboiler temperatures for conventional processes are higher than the operating range of R-134a as it is limited by its critical temperature of 101° C.

Because the boiling point of the present alcohol (64.7° C. for methanol) is lower than that of the amine solution, CO₂ stripping by alcohol vapour can be achieved at a lower temperature compared to the conventional stripping operations. The lower stripping temperature may provide an opportunity to use low-quality energy drawn from power plants or low-cost heat sources, such as hot water from geothermal fields. This can lead to a significant reduction in the cost of CO₂ capture. In addition, the lower stripping temperature also allows for the difference in operating temperature between absorber and stripper to be reduced, offering a potential reduction in heat-duty and size of the cross heat-exchanger used.

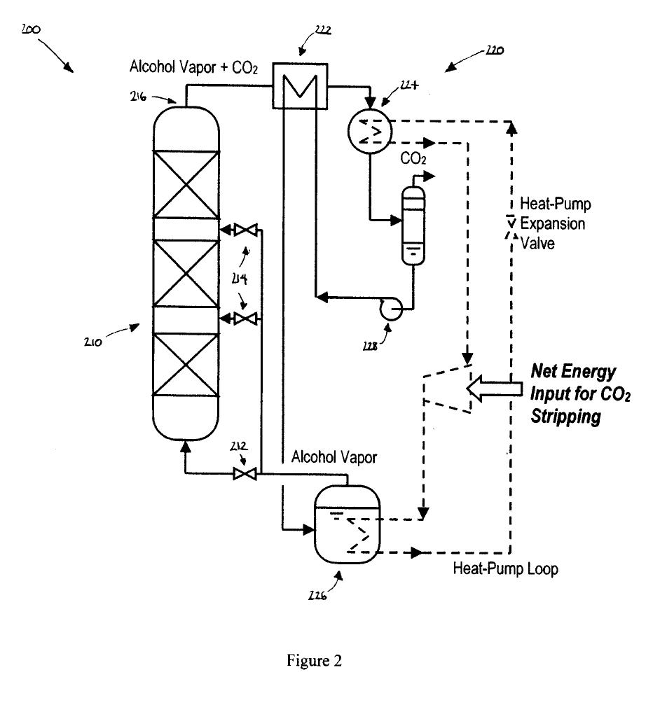

FIG. 2 is a schematic representation of an exemplary apparatus (200) suitable for operation therein of an exemplary process of the present disclosure for alcohol-based CO₂ stripping process from an adsorption column (210). The apparatus (200) includes a heat-recovery unit (220) for generation and recirculation of alcohol vapour within CO₂ stripping process. The CO₂-rich adsorption media is one of the adsorption bed where its operation is switched to the stripping mode. The CO₂-lean adsorption media obtained after stripping remains in the stripping column (210) where the operation is switched back to the adsorption mode. During the stripping process, an upward flow of hot alcohol vapour is introduced to the bottom (212) and at the sides (214) of the adsorption column. In the presence of stripping driving force, CO₂ is released from the adsorbent media and leaves the stripper top (216) with alcohol vapour. A vapour mixture of alcohol and CO₂ from the stripper is cooled by heat recovery (222) and overhead condensers (224) to separate alcohol and CO₂. The liquid alcohol is collected in an accumulator and then pumped with a liquid pump (228) through the recovery condenser (222) and a reboiler (226) to evaporate into alcohol vapour before being reused in the stripper. Since the alcohol used is always circulated within the system, its loss and makeup rely on appropriate operating conditions of the stripper. The amount of alcohol vapour required and a number of alcohol injection points along the stripper height will depend on the magnitude of stripping driving force that is required.

A preliminary assessment of a supercritical coal-fired power plant (Table 1) suggests that the proposed CO₂ stripping process using alcohol vapour carrier can be expected to offer an energy saving of approximately 29-37% contributing to a reduction in the energy penalty by 2.6-3.2% point drop.

TABLE 1
Preliminary Benefit Assessment of the Proposed CO₂ Stripping Process using Alcohol Vapour.

| | | Proposed CO₂ | Proposed CO₂ |
|---|---|---|---|
| | Conventional | Stripping by | Stripping using |
| | MEA Process | Alcohol (Case | Alcohol (Case |
| Conditions | (Base Case) | 1) | 2) |
| Evaluation Basis | Amine = MEA | Amine = MEA | Amine = MEA |
| Case 1: Rate of Stripping Carrier = Base Case | Conc = 30 wt % | Conc = 30 wt % | Conc = 30 wt % |
| Case 2: Rate of Stripping Carrier is greater than Base Case (the lower | | | |
| stripping temperature requires more stripping driving-force). | | | |
| Case 2: The lower stripping temperature yields a higher lean loading. | | | |
| Latent Heat of Vapourization (kJ/mol)^{a} | 40.6 (Water) | 35.2 (Methanol) | 35.2 (Methanol) |
| Rate of Stripping Carrier at Stripper Top (kmol/tonne CO₂) | 38.5 (Water) | 38.5 (Methanol) | 65.0 (Methanol) |
| Energy Components for CO₂ Stripping | | | |
| Heat of Reaction^{b} (GJ/tonne CO₂) | 1.945 | 1.945 | 1.945 |
| Sensible Heat for Amine Solution (GJ/tonne CO₂) | 0.690 | 0.690 | 1.020 |
| Heat of Vapourization of Stripping Carrier (GJ/tonne CO₂) | 1.565 | 1.357 | 2.288 |
| Total Stripping Energy at Reboiler (GJ/tonne CO₂) | 4.200 | 3.992 | 5.253 |
| Energy Recovered from condenser by Heat Pump^{c} (GJ/tonne CO₂) | 0^{d} | 1.357 | 2.288 |
| Net Energy Input from External Source (GJ/tonne CO₂) | 4.200 | 2.635 | 2.965 |
| Potential Energy Saving (%) | — | 37.26 | 29.40 |
| Energy Penalty of a Supercritical Coal-Fired Power Plant | | | |
| Power Plant Efficiency without CO₂ Capture (%) | 46.5 | 46.5 | 46.5 |
| Power Plant Efficiency with CO₂ Capture (%) | 37.9 | 41.1 | 40.5 |
| Energy Penalty (% point drop) | 8.6 | 5.4 | 6.0 |

^{a}Cengel, Y. A. and Boles, M. A., Thermodynamics: An Engineering Approach, 6^{th} Ed., McGraw Hill Higher Education, Boston, 2008.
^{b}Kohl, A. L. and Nielsen, R. B., Gas Purification, 5^{th} Ed., Gulf Publishing Company, Houston, 1997.
^{c}A heat pump is designed to operate at 10° C. (condenser cooling medium) and 90° C. (reboiler heating medium).
^{d}Temperature of reboiler in the conventional process (110-120° C.) is too high for heat pump application.

1. A method for stripping acid-gas from acid-gas rich media, wherein said method comprises:
contacting the acid-gas rich media with alcohol vapour whereby at least a portion of the acid gas is desorbed from the media by the alcohol vapour thereby forming an acid-gas lean media and an acid-gas rich alcohol; and
separating at least a portion of the acid-gas from the alcohol; and
recovering the alcohol.

2. A method according to claim 1 wherein the boiling point of the alcohol is lower than the boiling point of the media.

3. A method according to claim 1 wherein the acid gas is CO₂, H₂S, SO₂, NOₓ, or a combination thereof.

4. A method according to claim 1 wherein the media comprises an aqueous solution of amine selected from monoethanolamine (MEA), diglycolamine (DGA), diethanolamine (DEA), methyldiethanolamine (MDEA), 2-amino-2-methyl-1-propanol (AMP), piperazine (PZ), ammonia, amines, alkanolamines, derivatives thereof, and combinations thereof.

5. A method according to claim 1 wherein the media comprises kinetic enhancers, corrosion inhibitors, anti-foam agents, oxygen scavengers, salt neutralizers, anti-fouling agents, anti-degradation agents, or a combination thereof.

6. A method according to claim 1 wherein at least a portion of the waste heat from the acid-gas enriched alcohol is recovered and reused.

7. A method according to claim 1 wherein acid-gas lean alcohol is recovered from acid-gas rich alcohol by cooling the acid-gas rich alcohol to condense it, then heating the condensed alcohol to form an alcohol vapour which is reused for stripping acid-gas from rich media.

8. A method according to claim 7 wherein the cooling and the heating are provided by a heat recovery and exchange apparatus and a reboiler.

9. A method according to claim 1 wherein the alcohol is selected from methanol, ethanol, iso-propanol, n-propanol, and combinations thereof.

10. Use of an alcohol vapour for stripping an acid gas from an absorption medium and/or adsorption medium.

11. Use according to claim 10 wherein the acid gas is CO₂, H₂S, SO₂, NOₓ, or a combination thereof.

12. Use according to claim 10 wherein the absorption medium is an aqueous solution of amine selected from monoethanolamine (MEA), diglycolamine (DGA), diethanolamine (DEA), methyldiethanolamine (MDEA), 2-amino-2-methyl-1-propanol (AMP), piperazine (PZ), ammonia, amines, alkanolamines, derivatives thereof, and combinations thereof.

13. Use according to claim 10 wherein the media comprises kinetic enhancers, corrosion inhibitors, anti-foam agents, oxygen scavengers, salt neutralizers, anti-fouling agents, anti-degradation agents, or a combination thereof.

14. Use according to claim 10 wherein the alcohol is selected from methanol, ethanol, iso-propanol, n-propanol, and combinations thereof.

15. An apparatus for stripping an acid gas from an absorption medium, the apparatus comprising:
a stripping vessel for receiving therethrough a flow of acid-gas rich media, and for commingling therewith and therethrough an alcohol vapour whereby the media is depleted of at least a portion of said acid-gas and the alcohol vapour is enriched with said acid gas, said stripper vessel provided with an egress for the acid-gas depleted absorption medium and an egress for the acid-gas enriched alcohol vapour; and
equipment for receiving the egressing acid-gas enriched alcohol vapour, cooling said acid-gas enriched alcohol vapour to condense alcohol and separate therefrom at least a portion of said acid-gas.

16. An apparatus according to claim 15 wherein the egress for the acid-gas enriched alcohol vapour is about one end of the stripper vessel and the egress for the acid-gas depleted absorption media is about the opposite end.

17. An apparatus according to claim 15 wherein the equipment for receiving the egressing acid gas-enriched alcohol vapour comprises at least one heat-exchange device for recovering heat from at least one of the egressing alcohol vapour and the stripping vessel, and at least one heat exchange device for condensing the alcohol.

18. An apparatus for stripping an acid-gas from an adsorption medium, the apparatus comprising:
a stripping vessel having an adsorption medium for receiving therethrough a flow of acid-gas rich media wherein at least a portion of said acid-gas is adsorbed to said adsorption media,
equipment cooperative with the stripping vessel for commingling an alcohol vapour therewith and therethrough the adsorption media for stripping at least a portion of said adsorbed acid-gas therefrom thereby enriching the alcohol vapour with acid-gas, and an egress for the acid-gas enriched alcohol vapour; and
equipment for receiving the egressing acid-gas enriched alcohol vapour, cooling said acid-gas enriched alcohol vapour to condense alcohol and separate therefrom at least a portion of said acid-gas.

19. An apparatus according to claim 18 wherein the equipment for receiving the egressing acid gas-enriched alcohol vapour comprises at least one heat-exchange device for recovering heat from at least one of the egressing alcohol vapour and the stripping vessel, and at least one heat exchange device for condensing the alcohol.

20. An apparatus according to claim 15 or 18 further comprising equipment for condensing the recovered alcohol, heating the alcohol to form a vapour therefrom, and recycling the alcohol vapour to the stripping vessel.
